(19) United States
(12) Patent Application Publication
(10) Pub. No.: US 2020/0401617 A1
(43) Pub. Date: Dec. 24, 2020

(54) VISUAL POSITIONING SYSTEM

(71) Applicant: WHITE RAVEN LTD, Ramat-Gan (IL)

(72) Inventors: Ehud Spiegel, Petach-Tikva (IL); Shai Peer, Tel Aviv (IL); Boaz Shvartzman, Tahkemoni 1/1 (IL); Aaron Demri, Tel Aviv (IL); Ofer Avni, Ness-Ziona (IL)

(73) Assignee: WHITE RAVEN LTD, Ramat-Gan (IL)

(21) Appl. No.: 16/703,705

(22) Filed: Dec. 4, 2019

Related U.S. Application Data
(60) Provisional application No. 62/865,127, filed on Jun. 21, 2019.

(51) Int. Cl. G06F 16/587; G06F 16/532; G06K 9/62; G06F 16/58; G06N 3/08

(52) U.S. Cl. CPC G06F 16/587; G06F 16/532; G06N 3/08; G06F 16/5866; G06K 9/6228

(57) ABSTRACT

Systems and methods for image-based self-localization of an image capture device, include receiving a query image of an undetermined location of the image and comparing the query image to a set of geotagged reference images to determine a location of the query image. The system and method may alternatively compare a series of query images to reference images or portions of feature vectors generated from said query images and reference images to determine the closest query image in the series to respective reference images. The set of geotagged reference images may include a sequence of previously obtained reference images of a route, each reference image corresponding to a known geolocation. The geolocation of the user may be determined based on the location of the query image within the set. Ambient conditions of the images may be used to improve comparison of a query image to reference images. Segment and/or abstractions of cell images may be used to reduce computational and/or communications resources.

### CROSS-REFERENCE TO RELATED APPLICATIONS

The subject matter of this application relates to U.S. Pat. No. 10,043,097 and U.S. patent application Ser. No. 15/942,226, the disclosure of both are expressly incorporated by reference herein.

### BACKGROUND OF THE INVENTION

### 1. Field of the Invention

The invention relates to image-based location identification and more particularly to visual positioning systems and methods.

### 2. Description of the Related Technology

Computer vision is a field that includes methods for acquiring, processing, analyzing, and understanding images and, in general, high-dimensional data from the real world in order to produce numerical or symbolic information, e.g., in the forms of decisions. A theme in the development of this field has been to duplicate the abilities of human vision by electronically perceiving and understanding an image. This image understanding can be seen as the disentangling of symbolic information from image data using models constructed with the aid of geometry, physics, statistics, and learning theory. Computer vision has also been described as the enterprise of automating and integrating a wide range of processes and representations for vision perception.

As a scientific discipline, computer vision is concerned with the theory behind artificial systems that extract information from images. The image data can take many forms, such as video sequences, views from multiple cameras, or multi-dimensional data from a medical scanner. As a technological discipline, computer vision seeks to apply its theories and models to the construction of computer vision systems.

Sub-domains of computer vision include scene reconstruction, event detection, video tracking, object recognition, object pose estimation, learning, indexing, motion estimation, and image restoration.

In imaging science, image processing is any form of signal processing for which the input is an image, such as a photograph or video frame; the output of image processing may be either an image or a set of characteristics or parameters related to the image. Most image-processing techniques involve treating the image as a two-dimensional signal and applying standard signal-processing techniques to it.

Image processing usually refers to digital image processing, but optical and analog image processing also are possible. The acquisition of images (producing the data representative of an image in the first place) is referred to as imaging.

Closely related to image processing are computer graphics and computer vision. In computer graphics, images are manually made from physical models of objects, environments, and lighting, instead of being acquired (via imaging devices such as cameras) from natural scenes, as in most animated movies. Computer vision, on the other hand, is often considered high-level image processing out of which a machine/computer/software intends to decipher the physical contents of an image or a sequence of images (e.g., videos or 3D full-body magnetic resonance scans).

In modern sciences and technologies, images also gain much broader scopes due to the importance of scientific visualization (of often large-scale complex scientific/experimental data). Examples include microarray data in genetic research, or real-time multi-asset portfolio trading in finance.

Image analysis is the extraction of meaningful information from images; mainly from digital images by means of digital image processing techniques. Image analysis tasks can be as simple as reading bar coded tags or as sophisticated as identifying a person from their face.

Computers are indispensable for the analysis of large amounts of data, for tasks that require complex computation, or for the extraction of quantitative information. On the other hand, the human visual cortex is an excellent image analysis apparatus, especially for extracting higher-level information, and for many applications, including medicine, security, and remote sensing, human analysts still cannot be replaced by computers. For this reason, many important image analysis tools such as edge detectors and neural networks are inspired by human visual perception models.

Computer Image Analysis makes heavy use of pattern recognition, digital geometry, and signal processing.

It is the quantitative or qualitative characterization of two-dimensional (2D) or three-dimensional (3D) digital images. 2D images are, for example, to be analyzed in computer vision, and 3D images in medical imaging.

There are many different techniques used in automatically analyzing images. Each technique may be useful for a small range of tasks, however there still is no known method of image analysis that is generic enough for wide ranges of tasks, compared to the abilities of a human's image analyzing capabilities. Examples of image analysis techniques in different fields include:
2D and 3D object recognition
image segmentation
motion detection, e.g., single particle tracking
video tracking
optical flow
medical scan analysis
3D Pose Estimation
automatic number plate recognition.

Digital Image Analysis is when a computer or electrical device automatically studies an image to obtain useful information from it. Note that the device is often a computer but may also be an electrical circuit, a digital camera or a mobile phone. The applications of digital image analysis are continuously expanding through all areas of science and industry, including:
medicine, such as detecting cancer in an MRI scan
microscopy, such as counting the germs in a swab
remote sensing, such as detecting intruders in a house, and producing land cover/land use maps
astronomy, such as calculating the size of a planet
materials science, such as determining if a metal weld has cracks
machine vision, such as to automatically count items in a factory conveyor belt
security, such as detecting a person's eye color or hair color
robotics, such as to avoid steering into an obstacle
optical character recognition, such as automatic license plate detection
assay micro plate reading, such as detecting where a chemical was manufactured
metallography, such as determining the mineral content of a rock sample
defense
filtering.

Object-Based Image Analysis (OBIA)—also Geographic Object-Based Image Analysis (GEOBIA)—“is a sub-discipline of geoinformation science devoted to partitioning remote sensing (RS) imagery into meaningful image-objects, and assessing their characteristics through spatial, spectral and temporal scale”.

The two main processes in OBIA are (1) segmentation and (2) classification. Traditional image segmentation is on a per-pixel basis. However, OBIA groups pixels into homogeneous objects. These objects can have different shapes and scale. Objects also have statistics associated with them which can be used to classify objects. Statistics can include geometry, context and texture of image objects.

A geographic information system (GIS) is a system designed to capture, store, manipulate, analyze, manage, and present spatial or geographical data. The acronym GIS is sometimes used for geographical information science or geospatial information studies to refer to the academic discipline or career of working with geographic information systems and is a large domain within the broader academic discipline of Geoinformatics.

In a general sense, the term describes any information system that integrates, stores, edits, analyzes, shares, and displays geographic information. GIS applications are tools that allow users to create interactive queries (user-created searches), analyze spatial information, edit data in maps, and present the results of all these operations. Geographic information science is the science underlying geographic concepts, applications, and systems.

GIS has many applications related to engineering, planning, management, transport/logistics, insurance, telecommunications, and business. For that reason, GIS and location intelligence applications can be the foundation for many location-enabled services that rely on analysis and visualization.

GIS can relate unrelated information by using location as the key index variable. Locations or extents in the Earth space-time may be recorded as dates/times of occurrence, and x, y, and z coordinates representing, longitude, latitude, and elevation, respectively. All Earth-based spatial-temporal location and extent references should, ideally, be relatable to one another and ultimately to a “real” physical location or extent. This key characteristic of GIS has begun to open new avenues of scientific inquiry.

Modern GIS technologies use digital information, for which various digitized data creation methods are used. The most common method of data creation is digitization, where a hard copy map or survey plan is transferred into a digital medium through the use of a CAD program, and geo-referencing capabilities. With the wide availability of ortho-rectified imagery (both from satellite and aerial sources), heads-up digitizing is becoming the main avenue through which geographic data is extracted. Heads-up digitizing involves the tracing of geographic data directly on top of the aerial imagery instead of by the traditional method of tracing the geographic form on a separate digitizing tablet (heads-down digitizing).

GIS uses spatio-temporal (space-time) location as the key index variable for all other information. Just as a relational database containing text or numbers can relate many different tables using common key index variables, GIS can relate otherwise unrelated information by using location as the key index variable. The key is the location and/or extent in space-time.

Any variable that can be located spatially, and increasingly also temporally, can be referenced using a GIS. Locations or extents in Earth space-time may be recorded as dates/times of occurrence, and x, y, and z coordinates representing, longitude, latitude, and elevation, respectively. These GIS coordinates may represent other quantified systems of temporo-spatial reference (for example, film frame number, stream gage station, highway mile-marker, surveyor benchmark, building address, street intersection, entrance gate, water depth sounding, POS or CAD drawing origin/units). Units applied to recorded temporal-spatial data can vary widely (even when using exactly the same data, see map projections), but all Earth-based spatial-temporal location and extent references should, ideally, be relatable to one another and ultimately to a “real” physical location or extent in space-time.

Related by accurate spatial information, an incredible variety of real-world and projected past or future data can be analyzed, interpreted and represented.

GIS accuracy depends upon source data, and how it is encoded to be data referenced. Land surveyors have been able to provide a high level of positional accuracy utilizing the GPS-derived positions. High-resolution digital terrain and aerial imagery, powerful computers and Web technology are changing the quality, utility, and expectations of GIS to serve society on a grand scale, but nevertheless there are other source data that have an impact on overall GIS accuracy like paper maps, though these may be of limited use in achieving the desired accuracy since the aging of maps affects their dimensional stability.

The scale of a map and geographical rendering area representation type are very important aspects since the information content depends mainly on the scale set and resulting locatability of the map's representations. In order to digitize a map, the map has to be checked within theoretical dimensions, then scanned into a raster format, and resulting raster data has to be given a theoretical dimension by a rubber sheeting/warping technology process.

A quantitative analysis of maps brings accuracy issues into focus. The electronic and other equipment used to make measurements for GIS is far more precise than the machines of conventional map analysis. All geographical data are inherently inaccurate, and these inaccuracies will propagate through GIS operations in ways that are difficult to predict.

GIS data represents real objects (such as roads, land use, elevation, trees, waterways, etc.) with digital data determining the mix. Real objects can be divided into two abstractions: discrete objects (e.g., a house) and continuous fields (such as rainfall amount, or elevations). Traditionally, there are two broad methods used to store data in a GIS for both kinds of abstractions mapping references: raster images and vector. Points, lines, and polygons are the stuff of mapped location attribute references. A new hybrid method of storing data is that of identifying point clouds, which combine three-dimensional points with RGB information at each point, returning a “3D color image”. GIS thematic maps then are becoming more and more realistically visually descriptive of what they set out to show or determine.

Example of hardware for mapping (GPS and laser rangefinder) and data collection (rugged computer). The current trend for geographical information system (GIS) is that accurate mapping and data analysis are completed while in the field. Depicted hardware (field-map technology) is used mainly for forest inventories, monitoring and mapping.

Data capture—entering information into the system—consumes much of the time of GIS practitioners. There are a variety of methods used to enter data into a GIS where it is stored in a digital format.

Survey data can be directly entered into a GIS from digital data collection systems on survey instruments using a technique called coordinate geometry (COGO). Positions from a global navigation satellite system (GNSS) like Global Positioning System can also be collected and then imported into a GIS. A current trend in data collection gives users the ability to utilize field computers with the ability to edit live data using wireless connections or disconnected editing sessions. This has been enhanced by the availability of low-cost mapping-grade GPS units with decimeter accuracy in real time. This eliminates the need to post process, import, and update the data in the office after fieldwork has been collected. This includes the ability to incorporate positions collected using a laser rangefinder. New technologies also allow users to create maps as well as analysis directly in the field, making projects more efficient and mapping more accurate.

Remotely sensed data also plays an important role in data collection and consist of sensors attached to a platform. Sensors include cameras, digital scanners and LIDAR, while platforms may consist of aircraft and satellites. With the development of miniature UAVs, aerial data collection is becoming possible at much lower costs, and on a more frequent basis. For example, the Aeryon Scout was used to map a 50-acre area with a Ground sample distance of 1 inch (2.54 cm) in only 12 minutes.

When data is captured, the user should consider if the data should be captured with either a relative accuracy or absolute accuracy, since this could influence both how information will be interpreted and also the cost of data capture.

Data restructuring can be performed by a GIS to convert data into different formats. For example, a GIS may be used to convert a satellite image map to a vector structure by generating lines around all cells with the same classification, while determining the cell spatial relationships, such as adjacency or inclusion.

Spatial analysis with geographical information system (GIS) GIS spatial analysis is a rapidly changing field, and GIS packages are increasingly including analytical tools as standard built-in facilities, as optional toolsets, as add-ins or ‘analysts’. In many instances these are provided by the original software suppliers (commercial vendors or collaborative non-commercial development teams), whilst in other cases facilities have been developed and are provided by third parties. Furthermore, many products offer software development kits (SDKs), programming languages and language support, scripting facilities and/or special interfaces for developing one's own analytical tools or variants. The increased availability has created a new dimension to business intelligence termed “spatial intelligence” which, when openly delivered via intranet, democratizes access to geographic and social network data. Geospatial intelligence, based on GIS spatial analysis, has also become a key element for security. GIS as a whole can be described as conversion to a sectorial representation or to any other digitization process.

OpenCV (Open Source Computer Vision) is a library of programming functions mainly aimed at real-time computer vision. It is free for use under the open-source BSD license. The library is cross-platform. It focuses mainly on real-time image processing. The library has more than 2500 optimized algorithms, which includes a comprehensive set of both classic and state-of-the-art computer vision and machine learning algorithms. These algorithms can be used to detect and recognize faces, identify objects, classify human actions in videos, track camera movements, track moving objects, extract 3D models of objects, produce 3D point clouds from stereo cameras, stitch images together to produce a high resolution image of an entire scene, find similar images from an image database, remove red eyes from images taken using flash, follow eye movements, recognize scenery and establish markers to overlay it with augmented reality, etc. The OpenCV user community is more than 47 thousand people and estimated number of downloads exceed 18 million. The library is used extensively in companies, research groups and by governmental bodies. The library is available at www.opencv.org.

U.S. Pat. No. 10,043,097, assigned to the current applicant, shows an image abstraction engine provided to characterize scenes like typically found in an urban setting. In particular to characterize buildings and manmade structures have certain characteristic properties that may be abstracted and compressed in a manner that takes advantage of those characteristic properties. This allows for a more compact and computationally efficient abstraction and recognition.

Conventional “visual search” products (e.g. Google Goggles, CamFind, Cortica.com, etc.) do not attack the specific problem of place recognition. Homesnap, www.homesnap.com recognizes real estate using non-visual sensors. U.S. Patent Publication No. 2012/0321175 A1 shows a mobile device for performing real-time location recognition with assistance from a server. The approximate geophysical location of the mobile device is uploaded to the server. Based on the mobile device's approximate geophysical location, the server responds by sending the mobile device a message comprising a classifier and a set of feature descriptors. This can occur before an image is captured for visual querying. The classifier and feature descriptors are computed during an offline training stage using techniques to minimize computation at query time. Chen, Zetao, et al. “Convolutional Neural Network-based Place Recognition. “arXiv preprint arXiv:1411.1509 (2014), the disclosure of which is expressly incorporated herein, proposes to use Convolutional Neural Networks (CNNs) for place recognition technique based on CNN models, by combining features learned by CNNs with a spatial and sequential filter. The CNN described by Chen et al. uses a pre-trained network called Overfeat [Sermanet, et al., 2013] which was originally proposed for the ImageNet Large Scale Visual Recognition Challenge 2013 (ILSVRC2013). The Overfeat network is trained on the ImageNet 2012 dataset, which consists of 1.2 million images and 1000 classes.

Localization systems used in orientation play an important role in assisted navigation of both manned vehicles and unmanned autonomous vehicles such as cars or robots.

Self-location of a moving vehicle can be estimated based on information acquired from sensors mounted on the vehicle, such as, a rotary encoder, a gyro sensor, a camera and a laser distance sensor.

Current self-localization methods based on images are typically computationally expensive and are not feasible without additional position information. For example, Simultaneous Localization and Mapping (SLAM) utilizes multiple view feature descriptors to determine location despite appearance changes. However, conventional image processing techniques cannot support applications such as SLAM without accurate position information. Therefore, existing image based localization systems usually utilize data provided by satellite positioning systems, such as GPS (Global Positioning System) or global navigation satellite systems (GNSSs).

Unfortunately, GPS, which is not always available in all locations, does not currently provide the accuracy of location required in many self-localization scenarios and is thus unreliable. Other machine-based location systems suffer drawbacks that present challenges for use by a moving vehicle. Like GPS, RF-based methods are not available at all times in all locations. RF-based location services, such as Wi-Fi are limited to locations having available networks and accuracy is subject to network elements.

### SUMMARY OF THE INVENTION

It is an object to provide a system and method for real-time accurate image based localization even in GPS-denied locations. It is a further object to provide a computationally inexpensive solution for image based self-localization and mapping, which is not reliant on GPS. It is a further object to provide a system which increases the location accuracy even if a GPS or Wi-Fi (or other RF-based network) is available.

Wayfinding (or way-finding) encompasses all of the ways in which people orient themselves in physical space and navigate from place to place. The basic process of wayfinding involves four stages: (i) orientation is the attempt to determine one's location, in relation to objects that may be nearby and the desired destination; (ii) route decision is the selection of a course of direction to the destination; (iii) route monitoring is checking to make sure that the selected route is heading towards the destination; and (iv) destination recognition is when the destination is recognized.

The term “GPS” is meant to include any positioning system or method such as the Global Positioning System, the Global navigation satellite systems and other existing beacon or satellite based positioning systems.

It is a further object to determine a geolocation based on a set of reference images of a route or region indexed by location. The location of an image refers to the location of capture of the image. The location of capture is different than the location of an object appearing in an image. A geotag may identify the location of an image or a location of an object appearing in an image. A geotag may be a tag, label, or index that specifies a location. A geotag may not be absolutely accurate. The system allows for low resolution and drift or other inaccuracies, within a limit, in the specified location. A query image compared to a set of reference images of a route or other geotagged reference image database to determine a location of the query image capture. The reference image database may include a sequence of pre-obtained images of a route linked to known geolocations. The geolocation of the system can then be determined based on the location of the query image.

A geolocation may be determined based on a reference set which includes images linked to known ambient conditions. A query image obtained by a user during specific ambient conditions, may be compared to a sequence of images previously obtained during similar ambient conditions, to find a matching image in the sequence and a geolocation of the user is determined based on the matching image. In addition, a geolocation may need to be determined even if there is some change in ambient conditions. It is an object to provide a geolocation system with increased tolerance of changes in ambient conditions.

Traditional raster features are not robust enough to overcome the challenges attendant to variations in the outdoor scene. Conventional patch descriptors that describe an encapsulated point require too much time and computational resources for near real-time location recognition in a personal computing device. Outdoor scenes typically require hundreds of point features which make traditional recognition processes impractical in view of the computational performance and communication bandwidth which would otherwise be required. It is one object of the invention to facilitate abstraction, indexing and/or recognition of images and to take advantage of characteristics frequently present in images of locations of interest.

The system provides robust and enhanced abilities applicable in general circumstances including images of building and manmade structures and particularly useful in difficult to process scenarios such as images not having sufficient distinct characteristics to be easily differentiated. Repetitive straight lines, orthogonal elements, corners and other shapes which may be present in almost any environment, city, country, and nature can be differentiated with a higher level of confidence. Traditional image analysis and abstraction would require bandwidth and computational resources that make useful abstraction and identification with a mobile device, such as current conventional smartphones, camera phones, tablets and PDAs, impractical.

One process for characterizing an image is to use feature extraction. The system may be connected to a database containing reference image extractions feature maps and a neural network specifically trained to identify correspondence between a query input and a reference entry in a database. The correspondence may utilize ray-tracking.

The functions described herein may advantageously be performed on a computer system implementing OpenCV or another computer vision library of software solution. The neural net may be in a framework such as provided by TensorFlow. TensorFlow is an open-source software library for dataflow programming across a range of tasks. It is a symbolic math library and may be used for machine learning applications such as neural networks.

In image processing, feature extraction starts from an initial set of measured data and builds derived values (features) intended to be informative and non-redundant, facilitating the subsequent learning and generalization steps, and in some cases leading to better human interpretations. Feature extraction is related to dimensionality reduction. When the input data to an algorithm is too large to be processed and it is suspected to be redundant (e.g. the same measurement in both feet and meters, or the repetitiveness of images presented as pixels), then it can be transformed into a reduced set of features (also named a feature vector). Determining a subset of the initial features is called feature selection. The selected features are expected to contain the relevant information from the input data, so that the desired task can be performed by using this reduced representation instead of the complete initial data. Feature extraction involves reducing the amount of resources required to describe a large set of data. When performing analysis of complex data one of the major problems stems from the number of variables involved. Analysis with a large number of variables generally requires a large amount of memory and computation power, also it may cause a classification algorithm to overfit to training samples and generalize poorly to new samples. Feature extraction is a general term for methods of constructing combinations of the variables to get around these problems while still describing the data with sufficient accuracy.

It is a further object to find a Point of Interest (“POI”). A POI may be an area of an image, such as a building, or a door of a building, or simply a point on the wall, etc. An aspect of this may be accomplished by marking a POI over a scene in a reference image. “Scene recognition” may be used for finding in an image sequence the image having the closest scene to the reference image and then using the “Locate POI” process described below for finding and marking the POI in the image.

The operation flow may include processing reference images and query images. The processing of reference images may be performed in advance of the use of the system by a user for finding the marked POI. Reference images may be processed to generate reference feature vectors as described above. Query images may be processed in real-time to generate query feature vectors. The query feature vectors may be compared to reference feature vectors to find the closest match. The location of the closest matching reference feature vector is considered to be close to the location of the query feature vector.

The POI may be used to pinpoint the relative location of a POI to the query image.

The reference images may be processed in advance of the query operation. Reference images may be marked with points of interest. The knowledge of the location of a POI relative to a query image can be very useful. For example, a positioning or navigation process can be very accurately controlled because the location of a POI relative to the query image provides the opportunity to directly control the position of the query image capture relative to a POI. The relative location can be determined by examining a series of query images to determine which query image is the closest to the POI. The portion of the query image that corresponds to the marked POI in a reference image can be marked in the query image and selected and/or used. The image characteristics correlated to the POI present in the reference image may be marked or designated.

It is expected that the “closest” reference image location is next to or near the current location and the location of the closest location relative to the current query image location. This information, the relative location of the query image and the POI may be used to accurately control the device capturing the query image using reliably accurate sensors, for example, an accelerometer. A reliably accurate sensor such as an accelerometer may provide feedback to a motion control system, for example, with a much higher resolution than a GPS sensor in order to compensate for device movement and to identify angles (tilt, etc.) of the device that may help to compensate for alterations to [or changes in] the point of view. The relative location of a POI to the current location can be determined with a high degree of accuracy from the relative location of the closest location to the current location and the relative location of the POI to the nearest reference location.

According to a feature, a best match for an image may be identified when similarity between the image under consideration is measured against other images. The image in the sequence which has the highest level of similarity may be considered to be the best match, even if not an exact match. Reference images and the capture of query images are discrete operations. The density of reference images must be high enough to allow reliable correlation with a query image. In practice, it is not practical for the density of reference images in an area to be high enough to include a reference image that is identical to each query image. In practicality there will be few if any instances where a reference image is an exact match to a query image. The system is intended to compare images to find the best match. The best match for a specific reference image may be found by examining images known to be nearby, for example, from around a route or near anticipated geolocations. The knowledge of the location of a POI relative to the current location may be useful for navigating to the POI. The process may also be helpful to identify a missing POI or a significant change in a POI. To the extent that missing or changed POIs are encountered, remedial action may be required. If the missing POI is not the target of some action, there is an opportunity to correct or supplement the reference database. To the extent that it is the target, the operation may need to be canceled or altered.

This may be used in navigating to a POI using reference images and POIs.

### Scene Recognition

It is an object to provide a method for finding the approximate location of a moving camera, using a database of sparse position-tagged images. A dense position database contains ‘everything’ at the resolution needed from the car; for example, HD-Maps are a dense position database target for autonomous cars. The system described may rely on a sparse position database with a much lower density than sufficient alone for location and navigation. The density and sparse position database may take into account the constraints of the carrier of the camera, such as a car, constrained to mapped roads etc. The density and sparse position database may also take into account other factors such as weather, light affects, occlusions, and changes over time etc. This also allows improvement in the storage requirements and processing required to evaluate images in a reference database to identify approximate location of capture of a query image. The use of POls allows high accuracy position identification with a reduced computational demand. A reference data set may be images captured in advance which make up a sparse geotagged database of images. The images may have been captured from known locations, by an image capture device such as a dashboard camera in an urban scene.

In operation, a query video stream may be captured by a vehicle mounted camera. A significant mode of operation involves analyzing images in a query video stream to determine the closest match to a particular reference image, rather than the more traditional approach of finding which reference image best matches a query image. This is possible when the approximate location of the query image capture is known. The frames in the query video stream may be accessed to determine which best match any reference images in the database or at least any reference images known to be captured from a nearby location. This is computationally efficient and takes advantage of the understanding that given a known location or, even if approximate known location, of a vehicle, there is only a very limited number of reference image locations in the area of the vehicle. Because the reference images are associated with known locations, knowing a series of closest matches between a plurality of reference images and the time of the query image allows determination of the location of capture of query image with a reduced uncertainty in near-real-time with reasonably available computational (and communication) resources. These query-reference pairs support the construction of the cameras' trajectory, or constitute an anchoring system, complementing a drift-prone odometer. Construction of such a trajectory is useful to prediction of the camera capturing query images and selection of limited “nearby” reference images. The enhanced confidence in location as a result of use of a trajectory enables greater computational efficiency by reducing the reference image query image comparisons needed to find the best match.

A sequence of reference images may be composed/selected from locations along a possible route towards a destination. The query images in a query image stream may be compared to the reference images in the sequence to determine the best matches. The series of best matches confirms the actual path and location.

The design of visual positioning systems (VPS) may often rely on a database of dense position-tagged reference images, either for run-time matching or for training a CNN regressor. The former requires the use of a massive database at run-time, and the latter is (currently) unsuitable for large scale VPS applications. According to an aspect of the disclosure herein, the system may rely on a database of sparse position-tagged images (PTI—position-tagged image), which can be conceived of as “traps” for catching the camera when passing past them.

### Finding the Best Match

A similarity measurement tool, such as using a Deep Neural Network (“DNN”) may be used, with both reference and query images processed into a feature vector (may be a high dimensional descriptor vector). An example of the similarity measurement may be a cosine similarity or a hamming distance. The similarity score is expected to peak at the closest point of the cameras' trajectory to the reference position. Yet, the height of the peak may vary significantly on different passages and different reference images. Thus, the decision on highest similarity may require a delay due to the requirement to find a decrease in similarity before the similarity is found to be the highest. The delay may be by a few frames. If the similarity measure passes at least some wished threshold, and decreases consistently thereafter, the system may deduce that the best match is at that peak. Due to the complexity of images and image processing and optional noise in images, it may be advantageous to consider additional frames beyond a first frame with a decline in similarity. For example, the system may require a decline in at least three frames over a threshold distance, such as 30 meters, before there is sufficient confidence in the identification of the best match based on similarity.

In order to avoid spurious location detection, false peaks in similarity should be avoided. These false peaks may result from repetitive image elements. For example, a manmade structure may be similar and repetitive in a manner that might cause the system to recognize a peak in similarity at a false location. For example, a row of buildings may all have the same structural design and false peaks may be detected at each building. It is a further object to avoid spurious location detection caused by such false peaks. Spurious peaks might occur earlier in the trajectory (for example, in the case of repetitive architecture, causing visual aliasing) and be confused for the best match, resulting in false positioning.

In some areas the view is repetitive, assuming a long road with relatively similar building architecture trees etc., sometimes the views between two PTIs (“Position Tagged Images”) at distance of a 10-50 meters can looks the same and the DNN similarity is also very high, which means that it is difficult to distinguish between two images. This phenomena may increase with a decreased density of reference images and in a database of sparse position tagged images, measures must be taken to a disambiguate location.

One possibility for solving such issues is to sample every 50 meter—if two similar scenes exist in a ˜200 meters range, another sample may be taken ˜10 meters ahead of those similar scenes. The “extra” samples that creates “couples”—each with its nearest original sample, may be used together with the original samples to distinguish between two similar scenes, based on “couples” similarity.

If the view is similar between two PTIs that are far away from each other, it is also possible to use rough GPS signal or use the geographical order and consistency to filter false similarity (wrong places).

The PTI might be harder to find when the view is repetitive in a higher frequency. One way to deal with this aliasing challenge is to use a short sequence of PTIs that should appear in a certain order. The length of the sequence may be tuned according to the confusion level. The length also depends on the distance covered, and in cases of slow movement, gaps between frames are allowed.

### Database Optimization

If the sparse data set is obtained from a denser data set, the image for the sparse data set may be selected on the basis of similarity to nearby images. In some areas, including areas where reference images are highly similar the selection of reference images may require greater density of PTIs to be able to have a sufficient number of images that will result in a more accurate approximate location due to the possibility that the most similar reference image will not be “missing” from the reference data set.

### Locate POI

An aspect of the system is to provide a method for locating an area in a query image and matching an annotated area—a POI—in a reference image.

It is an object to identify and describe a location in a query image that corresponds to a known location of a point of Interest, or area of interest, in a reference image of a scene, such as an urban scene. This location may be identified and described using any method in the reference image. Specific examples of such a POI may be a certain point, a bounding box, or a contour of a building. The establishment, identification and description assumes that the query image is roughly of the same place, and may have been captured from a slightly different location and angle, and optionally at a completely different time or/and weather compared with the reference.

A dense feature extractor, such as a CNN, may be applied on both images. Rather than on-line application of the feature extractor to the reference images and storage of the entire feature map of reference images in an online reference database, it might be advantageous to store and process and avoid applying the feature extractor on-line on the reference image, as well as storing the whole feature map in the reference database; it may be advantageous to store and process online only a small fraction of distinctive points or segments, referred to here as anchors.

It is a further object to enhance the ability of the system to distinguish between similar reference images. The process of dense feature extraction may not be adequate to distinguish between images having the same features. The enhancement may be accomplished by identifying distinctive aspects of images referred to as traps. By focusing on the most distinctive elements in an image, it may be possible to avoid drawbacks attendant to the possibility of having identical (or nearly identical) feature vectors being generated from different reference images. The process may include estimating distinctiveness of feature points in a reference image and choosing the most distinctive as our anchors. A threshold may also be applied to further limit the reference dataset. At run time, a query image feature map may be processed to find an anchor.

A modified RANSAC may be used to find a geometrically consistent set of anchor-anchor-match pairs. RANSAC (random sample consensus) is a process to identify outliers in a set of data points. The anchor match by using this method may be accomplished with reduced computational resources.

According to an advantageous feature, the concept may be modified to use marked areas, for example, marked points of interest (POI) or areas of interest instead of or in addition to anchors. When an area of interest is marked over the reference image, that reference area of interest and the feature points defined only for this area of interest, may be the subject of further matching with corresponding areas of a query image. If the area of interest is a point, or very small, extracting anchor points in practice may use also the area surrounding it.

### Choice of Anchors

Corresponding points between reference and query images tend to score relatively high similarity measures based on the feature vectors at the corresponding points. Yet, many points might be similar to non-corresponding points as well. Given only the feature map extracted from the reference image, points which are the least likely to be similar to non-corresponding points in an unknown query feature map may be identified. This distinctiveness is in the reference image for choosing anchors in the reference mage without regard to whether they are distinct in the world may be extended to the world outside the reference image.

The points which are the least similar to any other (non-corresponding by definition) point in the same (reference) feature map are such points. The similarity between each feature vector and any other in the reference feature map may be used to choose the top num of anchors as anchors.

The similarity of each anchor to every point in a query feature map may be determined. The most similar point to an anchor may be selected as an “anchor match.” A transformation model from the reference POI to its correspondent in the query image may be fitted using RANSAC over the set of anchor-anchor-match pairs. The model may be established directly, or, if the number of its parameters is greater than 4, a coarse-to-fine like cascade of RANSAC processes may be used, starting with a simple (coarse) model, with 4 parameters, and adding complexity—and parameters—while using only the inliers of the last stage of the cascade. For example, if the required transformation is a homography, the minimal sample subset in the RANSAC process is 4. If there are many outliers, the chance of sampling an inlier subset might be very small, forcing us to compute too many samples for a real time process. The cascade of RANSAC processes may then become an enabler of a real time application of the method.

The RANSAC process may be modified by filtering out geometrically unreasonable or unlikely samples, thereby significantly reducing the number of full-fledged RANSAC iterations. The query image may be processed in the same way to obtain query anchors. Then a good match between the query anchors and the reference anchors may be identified and then a modified RANSC (ignoring outliers) may be used to reevaluate the degrees of match to confirm the accuracy. The entire reference base may be evaluated to pick the best result or a threshold that may be used where there is a determination that the degree of matching is sufficient.

After potential anchors are identified using the DNN, an anchor matching technique may look for a distinct anchor in a reference image. This anchor may be matched to an anchor in the query image. After a few anchors are paired, an anchor group may be identified where the geometrical relations between the anchors are maintained. Each match may be given a score (using the RANSAC). The score may be adjusted by the quality of the match determined by the geometrical similarity and the number of pairs included in the group. The match between the reference and the query image anchors may be estimated considering geometric relations between the anchors to determine to accept or reject the match.

Various objects, features, aspects, and advantages of the present invention will become more apparent from the following detailed description of preferred embodiments of the invention, along with the accompanying drawings in which like numerals represent like components.

Moreover, the above objects and advantages of the invention are illustrative, and not exhaustive, of those that can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

FIG. 1 schematically illustrates a system for image based self-localization and mapping.

FIGS. 2A-C schematically illustrate methods for image based self-localization and mapping in a known route.

FIGS. 3A-D schematically illustrate methods for image based self-localization and mapping using ambient conditions.

FIG. 4 shows an image-based location recognition system.

FIG. 5 shows a method for self-location which may be carried out by processor 102.

### DETAILED DESCRIPTION OF THE PREFERRED EMBODIMENT

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless defined otherwise, all technical and scientific terms used herein have the same meaning as commonly understood by one of ordinary skill in the art to which this invention belongs. It must be noted that as used herein and in the appended claims, the singular forms “a”, “an”, and “the” include plural referents unless the context clearly dictates otherwise.

Unless specifically stated otherwise, as apparent from the following discussions, it is appreciated that throughout the specification discussions utilizing terms such as “analyzing”, “processing,” “computing,” “calculating,” “determining,” “detecting”, “identifying”, “creating”, “producing”, “finding”, “combining” or the like, refer to the action and/or processes of a hardware based or software driven computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Unless otherwise stated, these terms refer to action of a processor or hardware.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention or work of an inventor. Further, the dates of publication provided may be different from the actual publication dates, which may need to be independently confirmed.

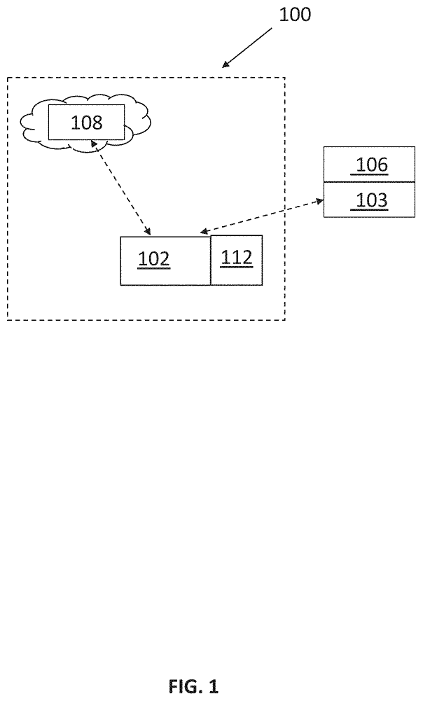

An exemplary system, which may be used for image based self-localization and mapping, is schematically illustrated in FIG. 1.

System 100 may include a processor 102 in communication with one or more camera(s) 103 and with a device, such as a user interface device 106 and/or other devices, such as storage device 108.

Components of the system may be in wired or wireless communication and may include suitable ports and/or network hubs. Components of the system may communicate via USB or Ethernet or appropriate cabling, etc.

Processor 102 may include, for example, one or more processors and may be a central processing unit (CPU), a graphics processing unit (GPU), a digital signal processor (DSP), a field-programmable gate array (FPGA), a microprocessor, a controller, a chip, a microchip, an integrated circuit (IC), or any other suitable multi-purpose or specific processor or controller. Processor 102 may be locally embedded or remote.

Processor 102 may receive image data (which may include data such as pixel values that represent the intensity of reflected light as well as partial or full images or videos) from the one or more camera(s) 103 and runs processes according to embodiments of the invention.

Processor 102 is typically in communication with a memory unit 112, which may store at least part of the image data received from camera(s) 103.

Memory unit 112 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

In some embodiments the memory unit 112 stores executable instructions that, when executed by processor 102, facilitate performance of operations of processor 102, as described herein.

System 100 may be a mobile device. Components of system 100 may be vehicle-mounted. System 100 may be wearable, like smart glasses. The components may be located in different physical devices.

For example, processor 102 may be integrated into an onboard vehicle computing system, a smartphone or networked to a remote location. Cameras 103 may be vehicle mounts or integrated into a vehicle or in a wearable device like smart glasses. User interface device 106 may be vehicle-mounted or part of a connected smart device, local or remote.

Storage device 108 may be a server including for example, volatile and/or non-volatile storage media, such as a hard disk drive (HDD) or solid-state drive (SSD). Storage device 108 may be connected locally or remotely, e.g., in the cloud. In some embodiments storage device 108 may include software to create and maintain databases of reference image sequences and reference images linked to known geolocations and/or known ambient conditions.

Camera(s) 103 is typically configured to obtain images of a route traveled, by a vehicle or otherwise. A vehicle may be a mobile or a moving device such as a robot, or any other traveling beings or devices such as a car, boat, or electric bicycles. Routes traveled by a vehicle may include routes in an urban environment or other outdoor or in-door environment. Thus, in one embodiment, a camera 103 may be placed and/or fixed to e.g., glasses worn by a person or to a vehicle, such that at least part of the route being traveled by the vehicle is within the field of view (FOV) of the camera 103.

Camera 103 is an image capture device and may include a CCD or CMOS or other appropriate chip and a suitable optical system. The camera 103 may be a 2D or 3D camera. In some embodiments the camera 103 may include a standard camera provided, for example, with mobile devices such as smart-phones or tablets.

In one embodiment, processor 102 receives a query image, namely, an image captured by camera 103 whose location is sought. Processor 102 compares the query image to reference images, which are previously captured images, and finds a matching reference image, typically based on similarities between the image and the reference image. The “match” need not be an identical match. The reference image may be matched to a query image based on an acceptable degree of similarity in the absolute sense or relative to other reference images.

In one embodiment, the reference images may be indexed by location. The set of reference images may be distributed over an area of interest. The area of interest may be a geographic region or be more limited, such as along a route or anticipated route. When used in a vehicle whose movement is limited, the set of images may be similarly limited. For example, a train-mounted system would only need images along train tracks. Processor 102 may access the location index for a matching reference image. The set of reference images may be a sequence of reference images of a route, each reference image may be linked to a known geolocation. The set of reference images indexed by location may be stored, for example, in storage device 108. Processor 102 may determine the geolocation of the user (or of the camera 103) based on the location best matching reference image, as further detailed herein.

In another embodiment, processor 102 receives a query image captured by camera 103 located in or on a vehicle, or carried by a person or other user. Processor 102 may compare the query image to a set of reference images, which are previously captured images linked to known ambient conditions. Based on the comparison, processor 102 may search for a matching reference image and determines the geolocation of the vehicle based on the matching reference image, as further detailed herein.

The term “ambient conditions” refers to conditions in the environment which affect the imaged scene. Such conditions may include, for example illumination levels and color in the environment being imaged. These conditions may be influenced, for example, by the season of the year, the time of day or night, the location within the city or other site, the amount of vegetation in the scene being imaged and more. Thus, ambient conditions may include time or location related descriptions. For example, ambient conditions may include conditions such as “summer”, “winter”, “evening”, “city center at noon”, “city center at night”, “countryside at night”, etc.

In some embodiments images obtained by camera 103 (e.g., still images or a video) may be displayed to a user, e.g., via user interface device 106. Augmented reality annotations and/or additional information may be added to the displayed images.

The user interface device 106 may include a display, such as a monitor or screen, for displaying images, instructions and/or notifications to a user (e.g., via text or other content displayed on the monitor). User interface device 106 may also be designed to receive input from a user. For example, user interface device 106 may include a monitor and keyboard and/or mouse and/or touch screen and/or a smartphone to enable user input.

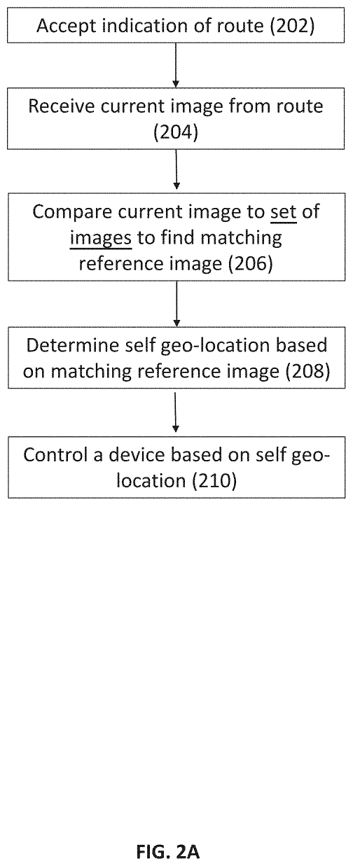

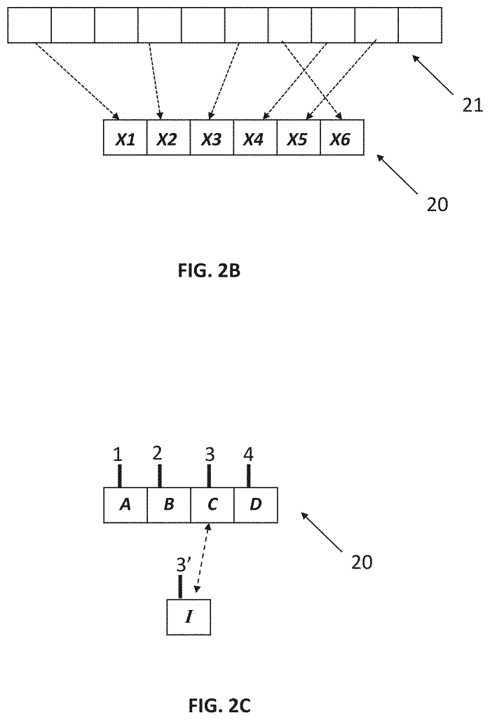

An example of a method for system self-location, which is carried out by processor 102, may be based on a process of comparing a query image to a set of reference images having known capture locations and extrapolating the location of capture of the query image from the capture location index of one or more of the closest reference images, as schematically illustrated in FIG. 2A.

In one embodiment, the method may include accepting an indication of route (or location) 202 and receiving an image (e.g., from camera 103) whose capture location is to be ascertained (also termed query image) (step 204) and comparing the query image to a set of reference images which includes a sequence of previously obtained images of a route, to find a reference image which matches the query image (step 206). Typically, each of the reference images in the set corresponds to a known geolocation. The step 202 may be based on a prior location determination or a GPS reading. The location need not be accepted as without error. The location of capture of the query image is determined to be at or near the location of capture of a matching reference image.

The set may include previously captured reference images of the specific route, each reference image corresponding to a known geolocation. It is possible to derive an ordered subset of reference images, the sequence of which corresponds to the specific route. Thus, processor 102 may determine the self-geolocation, i.e., the geolocation of the camera 103 used to capture the query image based on the geolocation of the matching reference image (step 208).

In another embodiment processor 102 may use the query image to update the reference image set. For example, a camera may capture an image of a location (e.g., location X) along the route from a viewpoint which may be used to enhance the set of reference images based on points of view or other ambient condition different from the viewpoint of one or more of the reference images that correspond to location X. This may be due to a unique capture location or a changing environment. Thus, the query image may be sufficiently similar to a reference image to ascertain location and still be useful to supplement a reference image set. The query image may be added to the set of reference images such that more viewpoints and/or appearances are available for comparison, thereby updating and improving the reference set. Thus, in some embodiments, storage device 108 may be controlled to update the reference images and location index in storage device 108.

In some embodiments the step of comparing the query image to the reference set (step 206) may include using a machine learning process. For example, a convoluted neural network (CNN) may be used. In one embodiment a CNN having a netVLAD component is used. A CNN may be used, which aggregates mid-level convolutional features extracted from an entire image, into a compact features vector representation that can be efficiently indexed. This may be achieved, for example, by plugging into the CNN architecture a generalized Vector of Locally Aggregated Features (Descriptor) layer (netVLAD) which will output an aggregated representation that can then be compressed (e.g., using Principle Component Analysis (PCA)) to obtain a compact descriptor of the image.

The vector representation (or other compact representation) of the image may be indexed, e.g., by using hashing methods, to facilitate retrieval of the images from the database during the comparing step (step 206). For example, Locality-sensitive hashing (LSH) can be used. Although LSH reduces the dimensionality of high-dimensional data, in a limited set of images (as obtained by embodiments of the invention), the possible loss of data is not a constraint but rather may provide better results than neural networks alone.

The images or compact descriptors of the images may be input to a Siamese network, which learns to differentiate between two inputs. A Siamese network consists of two identical neural networks, each taking one of the two input images. The last layers of the two networks are then fed to a contrastive loss function, which calculates the similarity between the two images. The output from the Siamese network may thus be used to compare between images and to find a match between a query image and a reference image.

In one embodiment, an example of which is schematically illustrated in FIG. 2B, a set of reference images 20 of a specific route may be created, for example, by traveling the route in advance while capturing reference images of the environment at known geolocations (e.g., known GPS coordinates) in the order of these locations within the route. A reference image may be captured once every few kilometers, meters or centimeters (for example), depending on the speed of travel and required resolution of the map.

In another example, a set of reference images 20 may be created by sampling images from reference image database 21, which are images at known geolocations of the world, such as panoramic views from positions along streets or other areas featured, for example, by Google™ Maps and Google™ Earth.

Typically, not all of the images of the set of images 21 are used to create set of reference images 20 (as illustrated by the dashed arrows).

In this embodiment map 20 includes an ordered subset of reference images, the sequence of which corresponds to a specific route, each reference image being linked or corresponding to a known geolocation. The order of the reference images in the sequence is typically route-dependent and is not necessarily the same order of the images in the set of images 21. For example, a pre-determined route may pass through locations X₁, X₂, X₃, X₄, X₅ and X₆, in that order. In this case, images of map 20 will be arranged such that an image (or images) of location X₁ will be first in the sequence, followed by an image (or images) of location X₂, followed by an image (or images) of location X₃ and so on, until location X₆, even though this was not necessarily the order of these images in the set of images from which set of reference images 20 was created.

In some embodiments, a set of reference images of a route may be created by processor 102 on the fly and may be dynamically changed based on locations the user passes and based on possible and probable routes as dictated by physical constraints in the real world, such as roads, railways, rivers, etc. For example, two consecutive geolocations of an image capture device may be determined to be X₁ and X₂. These locations may be mapped to a known map of routes (e.g., from Google™ Maps). In the map of routes, locations X₁ and X₂ are mapped to a set of reference images that proceeds through locations X₃, X₄, X₅ and X₆. For example, locations X₁ and X₂ may be mapped to a one way road in which a vehicle can only proceed by passing through locations X₃, X₄, X₅ and X₆. Thus, a probable route for a vehicle passing through locations X₁ and X₂ would include locations X₃, X₄, X₅ and X₆. In this case, processor 102 can select a set of reference images of the route based on a previously determined geolocation of the user (e.g., locations X₁ and/or X₂) and based on a probable route.

In one embodiment, an example of which is schematically illustrated in FIG. 2C, each of reference images A, B, C and D in the reference image set 20 for a route may have a location sensitive tag linked to it (tags 1, 2, 3, and 4, respectively). A location sensitive tag may include a textual, spatial or other description relating to the location of the images within the sequence of images that make up a reference image set 20 for a route. The location sensitive tags linked to reference images may be established as the reference database is curated and updated. In addition to location of the image within the sequence, the tags may also include geographical location and/or other information. Assigning or linking tags to images may be assisted by hints, such as the geolocation, the specific route, known velocity of the user traveling the route, etc., as further described below.

Location of an image within a sequence of images may be determined based on similarity between images, e.g., by using image analysis and/or machine learning techniques as described above. For example, reference image A may be compared to reference images B, C and D and determined to be most similar to reference image B, whereas reference image D is determined to be most similar to reference image C and reference image B is similar to both reference images A and C, and so on.

In one embodiment a location sensitive tag 3′ is assigned to a query image I and the tag 3′ is compared to the tags 1, 2, 3 and 4 linked to each of the reference images in the set of reference images 20, to determine a location of the query image I within the set of reference images 20. In this case tag 3′ is most similar to tag 3, thus, query image I is determined to be located at the location of reference image C (identified by tag 3) in set of reference images 20.

Comparing tags, rather than images requires less processing power and therefore provides a faster and more economic method for self-localization in real-time (or near real-time). Use of this method and other embodiments described herein, greatly improves and facilitates a self-localization and mapping device.

In some embodiments, determining the location of the query image I within set of reference images 20 can be done by using hints. For example, a known parameter of the user's (e.g., vehicle's) movement can be used to determine the location of the query image. Parameters of the vehicle's movement, such as velocity and/or acceleration of a vehicle, can be received, for example, from the telematics device of the vehicle, and can be used to provide an estimate of the vehicle's query location. In another embodiment, data from motion sensors and/or image processing to detect changes in consecutive images, can be used to estimate change in location over time and can be used to provide an estimate of the location of the image capture device.

For example, a set of reference images A, B, C and D is created for a pre-determined route which includes locations X₁, X₂, X₃ and X₄, in that order. Reference images A, B, C and D relate to locations X₁, X₂, X₃ and X₄, respectively. An image capture device traveling this route captures query images along the way and each current image is compared to the reference images of the map reference image set to determine a matching reference image, thereby to determine a geolocation of the user. Once a first current image is matched to reference image A, the second current image (a current image captured after the first query image was captured) may be compared to reference images B, C and D only, thereby limiting the search for a matching reference image. The search may be further limited by using, for example, the velocity or other parameter of the vehicle, for example, to calculate an estimated distance traveled from the last query location (e.g., location X₁ which corresponds to reference image A) to a subsequent query location. The estimated distance may indicate, for example, that the subsequent query image location is close to location X₄ such that the search for a matching reference image may be further limited to images C and D only.

In some embodiments the reference images A, B, C and D of the set of reference images 20 correspond to known ambient conditions in addition to corresponding to geolocations. The ambient conditions may be used to further limit the search for a matching reference image, thereby reducing the required processing power and providing an improved and facilitated self-localization and mapping device.

A query image may be compared to the sequence of reference images making up set of reference images 20, to find a matching image in the sequence, based on an ambient condition, as further detailed below.

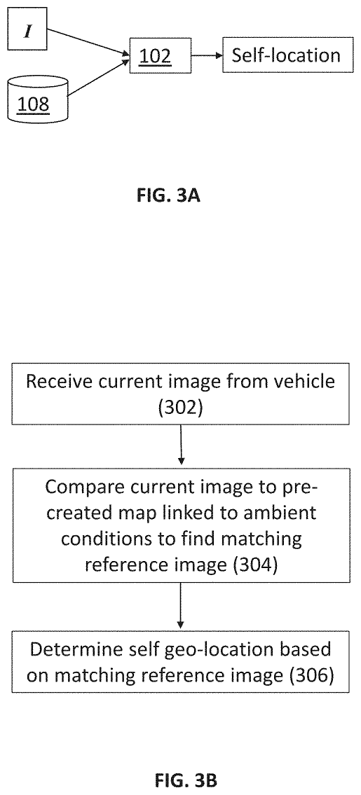

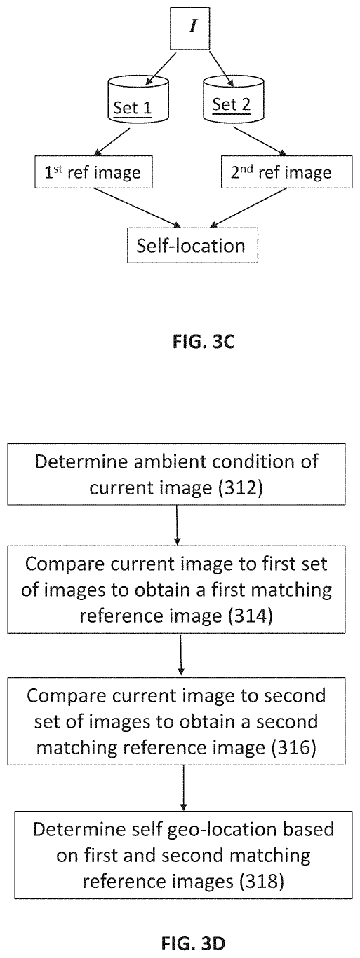

FIGS. 3A and 3B schematically illustrate a method for image based self-localization using ambient conditions. The method, which may be carried out by processor 102, may include receiving a query image I of an undetermined geolocation of the user (e.g., a vehicle) (step 302). Thus, query image I can be captured by a camera located at a point of interest such as in a vehicle or by a camera mounted on an object or carried by a user. The query image I is compared, at processor 102, to a set of reference images in a route (step 304), which can be maintained in storage device 108. The set of reference images may be linked to known ambient conditions, and the query image I is compared to the set of reference images to find a matching reference image. The geolocation of the vehicle (self-location) is determined based on the matching reference image (step 306).

In some embodiments, the location of the matching reference image within the sequence of the set of reference images is determined by processor 102. The geolocation of the image capture device can then be determined based on the location of the matching reference image within the sequence, as described above. The location of the matching reference image within the sequence can be used together with a known parameter of the movement of the image capture device to determine the geolocation of the image capture device, as described above.

Ambient conditions are conditions in the environment that affect the imaged scene. Ambient conditions may include time or location related descriptions. For example, ambient conditions may include conditions such as “summer”, “winter”, “evening”, “city center at noon”, “city center at night”, “countryside at night”, etc. A set of reference images linked to a known ambient condition is typically a set of images captured while the known ambient condition was prevailing. For example, a set of reference images linked to the ambient condition “nighttime” includes images captured during night hours, a map of reference images linked to the ambient condition “city center at night” includes reference images of a city center captured at night, and so on.

In one embodiment, the query image I is assigned to one or more ambient conditions. For example, a query image I captured in the city center area during the summer season may be assigned to the conditions “summer” and “city center”. Query image I will then be compared to a pre-prepared set of images assigned the condition “summer” and to a pre-prepared set of images assigned the condition “city center” (or to a single set assigned to both conditions).

Typically, the ambient conditions in the query image are determined prior to comparing the query image to the set of reference images, such that processor 102 may find a set of reference images linked to ambient conditions similar to those of the query image and may use this set in the comparison.

The ambient condition(s) of the query image may be determined automatically, for example, based on image analysis of the query image. For example, color detection algorithms and/or other known image analysis algorithms may be used to determine the ambient condition in a query image. In another embodiment, ambient condition(s) of the query image may be determined based on information automatically obtained from a time recording device associated with the user. For example, processor 102 may receive information from a clock of a vehicle to determine the time and/or date of a query image, and may deduce the ambient conditions from the time and/or date.

A set of reference images may be arranged in an ordered sequence (e.g., a sequence that corresponds to a specific route). As described above, comparing a query image to a set of reference images corresponding to known ambient conditions (step 304) can include assigning a location sensitive tag to the query image and comparing the tag of the query image to tags linked to each reference image in the sequence of reference images. A matching reference image is determined based on the comparison and its location within the sequence is determined to be the location of the query image within the sequence.

Hints, such as known parameters of the user's movement, can be used to find a matching reference image in the sequence.

Machine learning techniques, such as using a CNN (e.g., a CNN having a netVLAD component) and/or using a Siamese network can be performed in the comparison step. Additionally, a hashing method can be used to index the images for facile comparison.

In one embodiment, each reference image in the sequence of reference images may be linked to a known geolocation, in addition to being linked to an ambient condition, such that the geolocation of the query image is known from the matching reference image.

In another embodiment, examples of which are schematically illustrated in FIGS. 3C and 3D, the query image is compared to a first set of images linked to known geolocations and to a second set of images linked to ambient conditions.

A method for image based self-localization, according to one embodiment, includes determining ambient conditions of a query image I (step 312). The query image I is then compared to a first set of reference images (map 1) linked to known geolocations to obtain a first matching reference image (step 314). The current image I is then compared to a second set of reference images (reference image set 2) linked to ambient conditions (which are similar to the ambient conditions of the query image), to obtain a second matching reference image (step 316).

The geolocation of the query image capture (self-location of the user) is then determined based on the first matching image and the second matching image (step 318). In some embodiments, a device may be controlled based on the determined geolocation, for example, as described above.

The first matching reference image may serve to limit the search for the second matching reference image. For example, the first matching reference image, which can be detected based on machine learning techniques as described herein, may indicate a specific geographical location and may thus limit the next search to the specific geographical location. However, due to noise and changing conditions in the environment, the specific geographical location may not be accurate and may be a few meters off from the actual location of the image capture device while the query image is captured. The search for the second matching reference image will provide a more accurate match because noise, due to ambient conditions, is reduced in the second set of reference images, such that a more accurately matching image may be found and thus, a more accurate localization may be achieved. In addition, the search for the second matching reference image (which may also be carried out using the machine learning techniques described herein), is simplified because it can be restricted to the specific geographical area (and therefore restricted to a limited number of reference images).

In one embodiment, the query image is used to update the set of reference images linked to known ambient conditions.

In some embodiments, a geolocation of the first matching reference image and a geolocation of the second matching reference image can be combined to obtain a combined geolocation and the geolocation of the vehicle (or other user) is determined based on the combined geolocation. Combining geolocations may include, for example, calculating a statistical value such as an average or mean location. In some embodiments, a weight may be assigned to each of the first and second geolocations and the weighted locations are combined to obtain a combined geolocation. The geolocation of the query image may then be determined based on the combined geolocation, as demonstrated in the following equation:

L1*W1+L2*W2=Query Location

In which W1 and W2 are different weights, L1 is the location of the first reference image and L2 is the location of the second reference image.

In some embodiments the query image is captured in a specific route and the reference images are images previously captured at the specific route (possibly, during specific ambient conditions). In this case L1 and L2 may be locations of the images along the route.

Thus, locations L1 and L2 may refer to locations in the world (geolocations) and/or locations within a sequence of images.

Typically, in environments where ambient conditions are more significant (e.g., during a snow storm, during dark hours, etc.) the weight assigned to the location of images linked to ambient conditions is greater than the weight assigned to the location of images linked to geolocations.

Embodiments of the invention enable self-localization without relying on an external positioning system and provide more accurate localization than enabled by the existing positioning systems. Additionally, embodiments of the invention provide a quick and processing-wise economical method for self-localization and mapping based on visual data.

A specialized visual search engine may be utilized as a location recognition system. The visual search query may be an image of a location, for example, a location in a city. Image-based location recognition in an urban environment presents particular challenges created, in part, by repetitive man-made structures. Man-made structures such as buildings, fences, walls, and other repetitive structures make image differentiation and therefore recognition more challenging. An image-based location recognition system may rely on correspondence between a query image and a reference in order to identify and recognize a location.

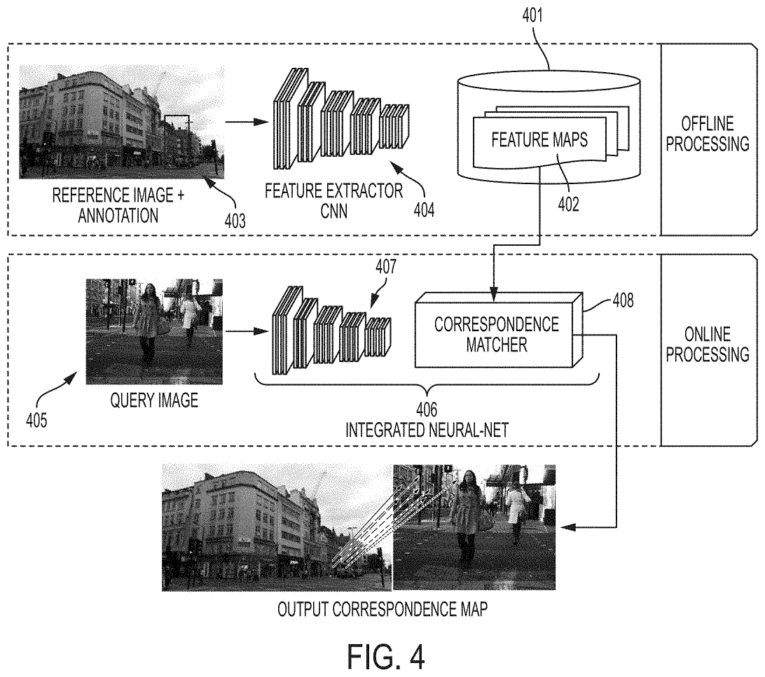

FIG. 4 shows an image-based location recognition system. Reference images and metadata 403 may be provided to a feature extractor 404. The feature extractor processes the reference images and generates a plurality of feature vectors, which collectively use feature maps 402 stored in a reference database 401. The establishment of the reference database may be an offline process, but may be supplemented, augmented, or updated over time utilizing the query images. The reference database 401 may store location references in the form of feature maps 402 describing an image of a particular location.

A query image 405 may be captured by any system which would benefit by recognition of a location by an image. A simple use would be a smartphone application which may allow a tourist to photograph a particular location with the intention that the system recognized the location and provides location-based information to the user. Location recognition according to a system as described may be used when other location services are inadequate. GPS-based location services are often not sufficiently responsive or accurate for certain applications. Traditional location services may be utilized to narrow the references in a reference database which may consulted for the location recognition. A query image 405 may be provided to an integrated neural network 406 for recognition. The integrated neural network 406 may include a feature extractor 407. The query image 405 may be provided to the feature extractor 407 which generates a query feature map provided to a correspondence matcher 408. The correspondence matcher 408 may be implemented within a neural network 406 in order to identify correspondence between a feature map generated by the feature extractor 407 from a query image 405 to a feature map generated from a reference image. The correspondence matcher 408 may output a correspondence map 409. The output correspondence map 409 reflects a confidence level in the query and reference image correspondence which indicates confidence in a location identification of the query image 405 as the location corresponding to the reference feature map 402.

The system may be maintained or updated by incorporating feature maps derived from actual images captured in the location recognition process into the reference database 401. A location may undergo changes over time. These changes may occur in small increments. The system may operate to recognize accurately a location which includes a small incremental change over the location when input as a reference. Over time, the location may be altered in an amount that is sufficient to defeat the location recognition based on an early reference image. The process of using query image feedback into the reference database 401 enhances the ability of the database to change over time to match changes in locations. Advantageously, very small changes, such as occlusions which may be caused by temporal presence by individuals or vehicles, need not be incorporated into the reference database.

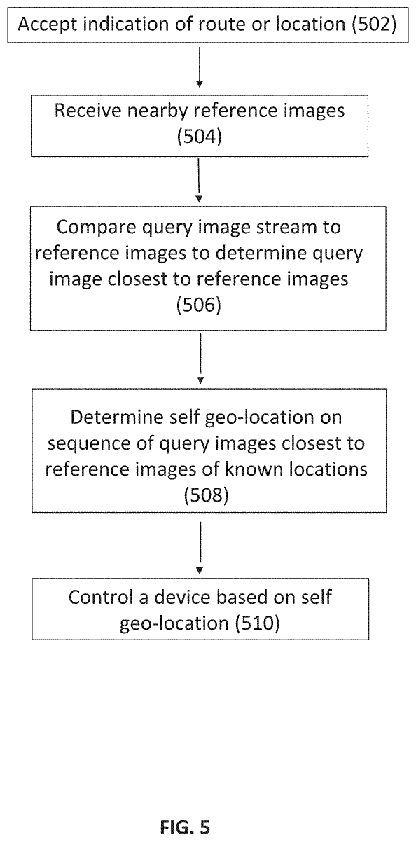

According to an advantageous embodiment, scene recognition may be accomplished by finding the approximate location of a moving camera, using a database of sparse position-tagged images. A process for self-location is shown in FIG. 5.

An aspect of this process is to use anchors or traps designated in the reference images in a sparse geo-tagged reference database. The trap may be a segment of an image that is easily recognized by image processing techniques. A series of query images may be captured by a vehicle-mounted or user-carried image capture device 103, for example a camera. Once the process identifies a general vicinity of the image capture device, it may select a feature in a reference image generally corresponding to the location. Successive query images may be evaluated to determine the level of correlation between the trap segment of the reference image and the query image as the level of correlation increases, the evaluation determines that the position of the image capture device is getting closer to the known location of the reference image until the level of correlation begins to decrease. At that point, the closest query position is known. The level of correspondence increases as the query image and reference images converge. The highest level of correspondence between a reference image and a query image when the capture location of the respective images is at the closest location to each other. This is because image capture for both reference sets and query sets are discrete. This process is repeated for other reference image locations. By determining a sequence of positions corresponding to the closest position to a series of known locations, the current location of a query image may be found. Correspondence may be determined by various techniques and represents a degree of match between two images. Correspondence may be determined by a correlation function. Other measures may also be used including, but not limited to, edge or pixel matching/comparison.

FIG. 5 shows an example of a method for self-localization, which may be carried out by processor 102.

The method may include accepting an indication of route or location 502 and includes receiving nearby reference images or reference image data and a sequence of images (e.g., from camera 103) whose capture location is to be ascertained (also termed query image) (step 504). The sequence of query images is compared to the reference images to find a query image closest to one or more of the reference images (step 506). Each of the reference images corresponds to a known geolocation. The location of capture of a matching reference image is used to determine self-geolocation, step 508.

The set of reference images may include previously captured reference images of the specific route, each reference image corresponding to a known geolocation. It is possible to derive a subset of reference images, near to a known or estimated location which corresponds to the vehicle location. Thus, processor 102 may determine the self-geolocation, i.e., the geolocation of the camera 103 (which is located on or attached to a vehicle which matches the query image), based on the geolocation of the reference images (step 208).

In some embodiments the vehicle may be controlled based, in part, on the determined self-geolocation (step 510). For example, the user interface device 106 may be controlled to display the query image and to further display an annotation or other mark related to the geolocation of the vehicle at the time the query image was captured.

According to an advantageous feature, these traps are sufficiently dense in the reference dataset that will ensure that a trap is located in a reference image sufficiently near any major segment of a path to be recognized.

The process is repeated for other reference images around the known area of the vehicle. The location of each trap is known and may be used as an accurate positioning point. The approximate position relative to a trap may be calculated. The error of that calculation decreases as the query image nears. The smallest error exists at the closet point to a trap. The movement between the traps is also tracked using relevant measurements, and all together—an accurate locating, tracking and mapping of a path is determined.

Another feature for locating a point of interest (“POI”) is a method for locating an area in a query image and matching an annotated area in a reference image. The location of a POI measures the match to the reference image and may operate to reduce the amount of an image processed to an area of interest.

The use of traps may be either for a whole reference image or on areas of interest of the reference image. The traps may represent POIs appearing in an image, for example, billboards, shops, buildings, windows, etc.

For a situation where there is a high frequency of repetitive images, the process will find a match only if there is a sequence of matches. In order to determine the length of a sequence large enough to extend outside of the repetitive zone, the sequence length may be extended until it is sufficiently unique to a threshold confidence. This may rely on a combination of traps and POls. POI may be used to mark a specific area as a trap, the scene recognition traps-building will make sure that the trapping sequence will ensure a unique result.

The system may include apparatus and a method for detecting changes through using the approximate location of a moving camera.

Once a path of travel covered with traps is determined, a certain trap (or few consecutive traps) may encounter a significant reduction in its matching qualities. If it is determined that there is a good match quality on a path before and after a zone of reduced match quality, it may be inferred that there has been a change to a portion of the path that is not recognized in the reference database. This may be used to generate a report of an area which should be scanned to update the reference database. As an alternative to rescanning or to temporarily upgrade the reference database pending a rescan, the query image stream may be used.

The invention is described in detail with respect to preferred embodiments, and it will now be apparent from the foregoing to those skilled in the art that changes and modifications may be made without departing from the invention in its broader aspects, and the invention, therefore, as defined in the claims, is intended to cover all such changes and modifications that fall within the true spirit of the invention.

Thus, specific apparatus for and methods of abstraction of images has been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method for image based self-localization of a user comprising the steps of:
receiving one or more query images at a processor;
identifying an approximate location of query image capture;
selecting a subset of geotagged reference images proximal to said approximate location of query image capture, wherein said reference images, each correspond to a known geolocation;
using the processor to compare said query images to a said subset of geotagged reference images to determine which reference image most closely matches a query image; and
using the processor to determine a geolocation of the capture of said query image by reference to the geotag of the reference image most similar to said query image.

2. The method of claim 1 comprising using the processor to control a device based on determination of the geolocation of the user.

3. The method of claim 1 comprising:
assigning a location sensitive tag to the query image; and
comparing the tag of the query image to tags linked to each reference image to determine the location capture of the query image.

4. The method of claim 1 comprising using the processor to determine the location of capture of the query image within the reference images based on a known parameter of the user's movement.

5. The method of claim 1 wherein the step of comparing comprises using a Convolutional Neural Network.

6. The method of claim 1 wherein the reference images are linked to known ambient conditions.

7. The method of claim 1 comprising using the query image to update the reference images.

8. The method of claim 1 comprising using the processor to select a subset of reference images based on a previously determined geolocation of the image capture and based on a probable route.

9. The method of claim 1 comprising:
assigning a location sensitive tag to the query image;
comparing the tag assigned to the query image to tags linked to each reference image in the sequence of reference images, the tags sensitive to location of each reference image within the sequence, to determine a location of the query image within the sequence; and
determining the matching image based on the location of the query image within the sequence.

10. The method of claim 9 wherein determining ambient conditions is based on information automatically obtained from a time recording device associated with the user.

11. The method of claim 10 comprising:
determining a location of the first matching reference image within a sequence of the first set of reference images to determine a first geolocation;
determining a location of the second matching reference image within a sequence of the second set of reference images to determine a second geolocation;
combining the first and second geolocations to a combined geolocation; and
determining the geolocation of the user based on the combined geolocation.

12. The method of claim 1 comprising using the query image to update the sequence of images linked to known ambient conditions.

13. The method according to claim 1 wherein one or more reference images are processed to determine features that contrast similar reference images proximal said one or more references image(s);
weighting said features that contrast in the reference images in the processor determination of similarity of said reference images to said query image.

14. A method for self-geolocation comprising the steps of:
determining approximate location of a query image capture;
identifying a geotagged reference image captured proximally to said location of said image capture, wherein said geotagged reference image includes a marked point of interest;
comparing a series of query images to said identified geotagged reference image to find the query image that best matches the reference image;
tracking a current location relative to a location of capture of the query image that best matches the reference image.

15. The method according to claim 14 further comprising the step of identifying aspects of a query image corresponding to a marked point of interest in said reference image to determine the relative location of the query image that best matches the reference image and the geotagged position of the reference image.
